(19) United States
(12) Patent Application Publication
(10) Pub. No.: US 2019/0325400 A1
(43) Pub. Date: Oct. 24, 2019

(54) COMPUTER-READABLE RECORDING MEDIUM, MACHINE LEARNING METHOD, AND MACHINE LEARNING DEVICE

(71) Applicant: FUJITSU LIMITED, Kawasaki-shi (JP)

(72) Inventors: Izumi NITTA, Kawasaki (JP); Tatsuru MATSUO, Kawasaki (JP)

(73) Assignee: FUJITSU LIMITED, Kawasaki-shi (JP)

(21) Appl. No.: 16/366,644

(22) Filed: Mar. 27, 2019

(30) Foreign Application Priority Data
Apr. 20, 2018 (JP) 2018-081900

(51) Int. Cl. G06Q 10/10; G06N 3/08; G06N 20/00

(52) U.S. Cl. CPC G06Q 10/1091; G06N 20/00; G06N 3/084

(57) ABSTRACT

The learning device receives attendance record data constituted of a plurality of records for a plurality of employees, the attendance record data corresponding to a period of a calendar and including a plurality of records including a plurality of items. The learning devices generates exclusion data by excluding a record corresponding to an individual holiday that is differently set by the employees, and a record corresponding to a common holiday set commonly to the employees. The learning device generates, based on the generated exclusion data, tensor data in which a tensor is created with calendar information and the items including different dimensions. The learning device performs deep learning of a neural network and learning of a method of tensor decomposition with respect to a learning model in which the tensor data is subjected to the tensor decomposition as input tensor data to be inputted to the neural network.

### CROSS-REFERENCE TO RELATED APPLICATION

This application is based upon and claims the benefit of priority of the prior Japanese Patent Application No. 2018-081900, filed on Apr. 20, 2018, the entire contents of which are incorporated herein by reference.

### FIELD

The embodiments discussed herein are related to a computer-readable recording medium, a machine learning method, and a machine learning device.

### BACKGROUND

Predicting mentally unwell conditions of employees in a few months later based on their attendance records data and taking some actions such as counseling in earlier stages to present them from taking a suspension of work (sick leave) has been performed. Generally, dedicated staff members perform a visual check to find an employee who falls on work conditions with feature patterns such as frequent business trips, long overtime, repeated sudden absences, absence without notice, and a combination of these patterns. It is difficult to clearly define these feature patterns, because such dedicated staff members may individually have their own standards. In recent years, machine learning using a decision tree, random forest, SVM (Support Vector Machine), or the like has been performed to learn feature patterns specific to mentally unwell conditions including sickness and to automatically provide a prediction, which has been decided by the dedicated staff members. Examples of related art are described in International Publication Pamphlet No. WO 2017/073373, Japanese Laid-open Patent Publication No. 2010-198189, Japanese Laid-open Patent Publication No. 2016-151979, and Japanese Laid-open Patent Publication No. 2005-332345.

With the above-described technique, however, in some cases, learning of a wrong feature pattern may proceed and result in degradation of the accuracy of learning. For example, there is a possibility that wrong learning proceeds with taking day off, not making attendance, on holidays such as Saturdays, Sundays, national holidays, and a summer vacation and a refresh vacation supplied by a company being recognized as a feature pattern common to many persons, thereby overlooking a true feature pattern that has a large effect on unwell conditions and preventing true learning from proceeding.

### SUMMARY

According to an aspect of an embodiment, a non-transitory computer-readable recording medium having stored therein a program that causes a computer to execute a process. The process includes receiving attendance record data for a plurality of employees, the attendance record data corresponding to a period of a calendar, the attendance record data including a plurality of records including a plurality of items, first generating exclusion data by excluding a record corresponding to an individual holiday that is differently set by the employees, and a record corresponding to a common holiday set commonly to the employees, from the attendance record data; second generating, based on the generated exclusion data, tensor data in which a tensor is created with calendar information and the items including different dimensions; and performing deep learning of a neural network and learning of a method of tensor decomposition with respect to a learning model in which the tensor data is subjected to the tensor decomposition as input tensor data to be inputted to the neural network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a whole example of machine learning according to a first embodiment;

FIG. 2 is a diagram exemplifying a relation between a graph structure and a tensor;

FIG. 3 is a diagram exemplifying extraction of a partial graph structure;

FIG. 4 is a diagram for explaining a learning example of Deep Tensor;

FIG. 5 is a functional block diagram illustrating a functional structure of a learning device according to the first embodiment;

FIG. 6 is a diagram illustrating an example of attendance record data stored in an attendance record data database (DB);

FIG. 7 is a diagram for explaining an example of label setting;

FIG. 8 is a diagram for explaining a specific example of creating a tensor;

FIG. 9 is a diagram for explaining tensor representation in which a relevant holiday is excluded from elements of a tensor;

FIG. 10 is a diagram for explaining tensor representation for an excluded relevant holiday portion;

FIG. 11 is a diagram for explaining an example of generating a core tensor according to the first embodiment;

FIG. 12 is a diagram for explaining the problem that is caused by general machine learning;

FIG. 13 is a flowchart illustrating a flow of learning processing;

FIG. 14 is a diagram for explaining another example of a prediction method; and

FIG. 15 is a diagram for explaining an example of a hardware configuration.

### DESCRIPTION OF EMBODIMENTS

Preferred embodiments will be explained with reference to accompanying drawings. This embodiment is, however, not intended to limit the scope of the present invention in any way. Moreover, it is possible to combine the embodiments one another as appropriate within a scope without inconsistency.

### [a] First Embodiment

### Whole Example

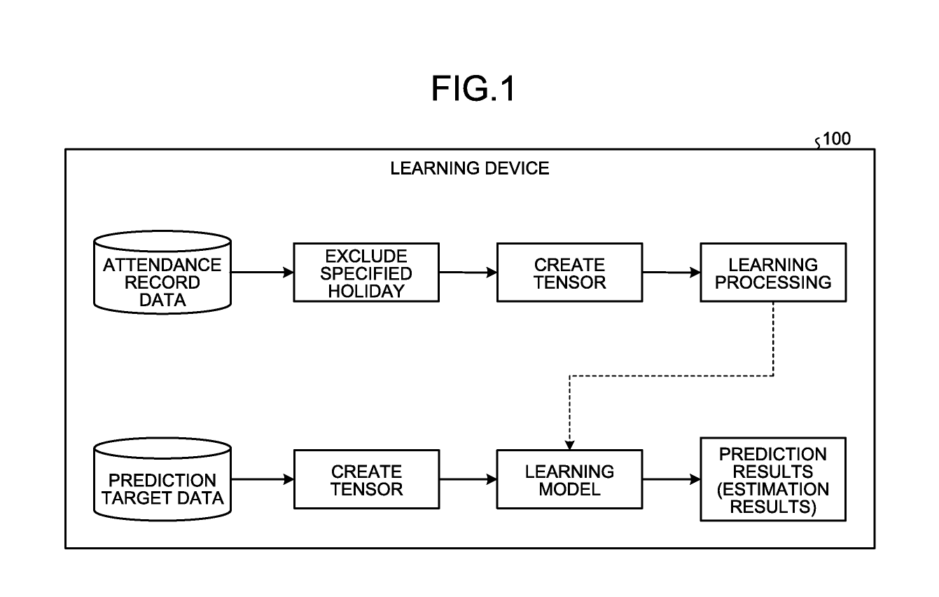

FIG. 1 is a diagram for explaining a whole example of machine learning according to a first embodiment. As illustrated in FIG. 1, a learning device 100 according to the first embodiment is an example of a machine learning device. The learning device 100 is an example of a computer device that generates a learning model through machine learning on attendance record data for employees including their daily statuses of attendance, attendance and leave times, taking a holiday, and a business trip, and using the learning model after learning, predicts whether a certain prediction target employee will take sick leave, from the attendance record data of that employee. Although the example that the learning device 100 executes both learning and prediction is explained, different devices may execute learning and prediction separately.

To be specific, the learning device 100 generates a learning model using Deep Tensor (registered trademark) that performs deep learning (DL) on graph-structured data with attendance record data (label: with sick leave) of an unwell person who has taken sick leave (suspension of work) and attendance record data (label: without sick leave) of a person who has not taken sick leave (suspension of work) as supervised data. Then, the learning device 100 uses the learning model to which learning findings are applied to implement inference for an accurate event (label) with respect to a new graph-structured data.

For example, the learning device 100 acquires attendance record data constituted of a plurality of records for a plurality of employees, the records each corresponding to a period of a calendar and having a plurality of items. Then, the learning device 100 excludes, from the attendance record data, a record corresponding to individual holidays that are individually set by a plurality of employees and a record corresponding to a holiday on which attendance is not made among specified holidays including common holidays set commonly to the employees such as Saturdays, Sundays, and national holidays, and generates tensor data in which a tensor is created with calendar information and a plurality of items having different dimensions. After that, the learning device 100 performs deep learning of a neural network and learning of a method of tensor decomposition with respect to a learning model in which the tensor data is subjected to the tensor decomposition as input, so as to be input to the neural network. In this manner, the learning device 100 generates a plurality of pieces of learning data from the attendance record data and generates a learning model to provide classification into “take sick leave” and “not take sick leave” based on the tensor data of each piece of learning data.

After that, the learning device 100, similarly to the attendance record data of an employee who is to be determined, excludes a holiday on which attendance is not made among the specified holidays, then creates a tensor to generate tensor data, and inputs the tensor data to the learned learning model. The learning device 100 outputs an output value representing prediction results whether the target employee “takes sick leave” or “does not take sick leave”.

That is, the learning device 100 excludes a feature of a day on which attendance is not made, the day being a holiday, from learning data and prediction data. Holidays include common holidays set commonly to the employees such as Saturdays, Sundays, and national holidays, individual holidays that are set differently by the employees such as a summer vacation and a refresh vacation, and leave and the like supplied by the company. When attendance is made on a holiday, this attendance is not excluded from learning data and prediction data, but is left therein. In such a manner, the learning device 100 focuses a feature of the day on which attendance is made, thereby eliminating noise to improve the accuracy of learning.

The following explains Deep Tensor. Deep Tensor is a deep learning with a tensor (graphic information) as input. Deep Tensor extracts a partial graph structure that contributes to a determination, together with learning a neural network. This extraction processing is provided by learning parameters for tensor decomposition of input tensor data together with learning a neural network.

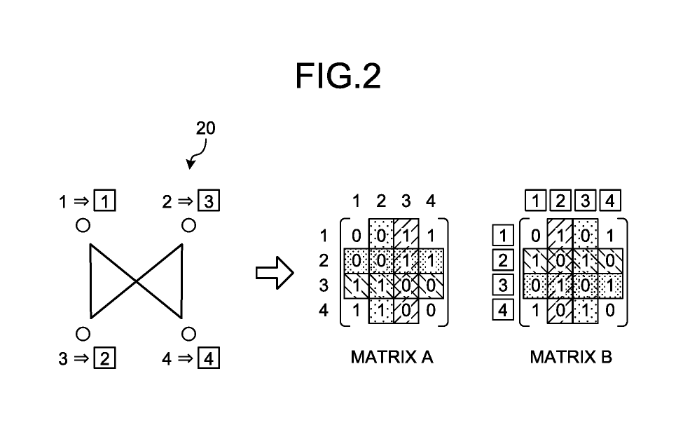

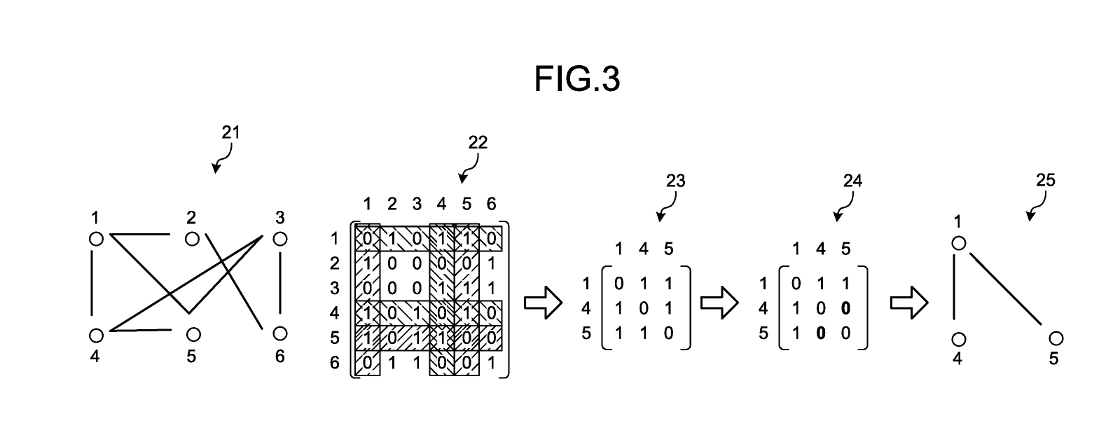

Next, the following explains a graph structure with reference to FIGS. 2 and 3. FIG. 2 is a diagram exemplifying a relation between a graph structure and a tensor. In a graph 20 of FIG. 2, four nodes are tied with an edge representing a relation between the nodes (for example, “a correlation factor is equal to or greater than a certain value”). It is indicated that the nodes that are not tied with the edge do not have the above-described relation. When the graph 20 is expressed with a second order tensor, that is, a matrix, a matrix representation based on numbers on the left side of the nodes is represented as “matrix A” and that based on numbers on the right side of the nodes (numbers surrounded with boxes) are represented as “matrix B”, for example. The components of each of these matrices are represented as “1” where nodes are tied (connected), and as “0” where nodes are not tied (not connected). In the following explanation, the above-described matrix is also referred to as the adjacency matrix. It is possible to create the “matrix B” by swapping the second row and the third row and swapping the second column and the third column of the “matrix A”. Deep Tensor performs processing ignoring the difference of the order by using this swap. That is, Deep Tensor ignores the ordinality of the “matrix A” and “matrix B” and treats the matrices as the same graph. The same processing is performed also for the third or higher order tensor.

FIG. 3 is a diagram exemplifying extraction of a partial graph structure. In a graph 21 of FIG. 3, six modes are tied with an edge. The graph 21 is represented as a matrix 22 by being expressed with a matrix (tensor). With respect to the matrix 22, it is possible to extract a partial graph structure by combining an operation to swap specific rows and specific columns, an operation to extract a specific row and a specific column, and an operation to replace a non-zero element with zero in an adjacency matrix. For example, extracting a matrix corresponding to “nodes 1, 4, 5” of the matrix 22 produces a matrix 23. Next, replacing a value between “nodes 4, 5” of the matrix 23 with zero produces a matrix 24. A partial graph structure corresponding to the matrix 24 produces a graph 25.

Such processing to extract a partial graph structure is implemented by a mathematical operation referred to as tensor decomposition. Tensor decomposition is an operation to approximate the input n-th order tensor with a product with the n-th or lower order tensor. For example, the input n-th order tensor is approximated with a product of the one n-th order tensor (referred to as a core tensor), and n tensors the order of which is lower than n-th (when n>2, normally the second order tensor, or matrix, is used). This decomposition is not unique, but any desired partial graph structure in the graph structure represented by the input data is able to be included in the core tensor.

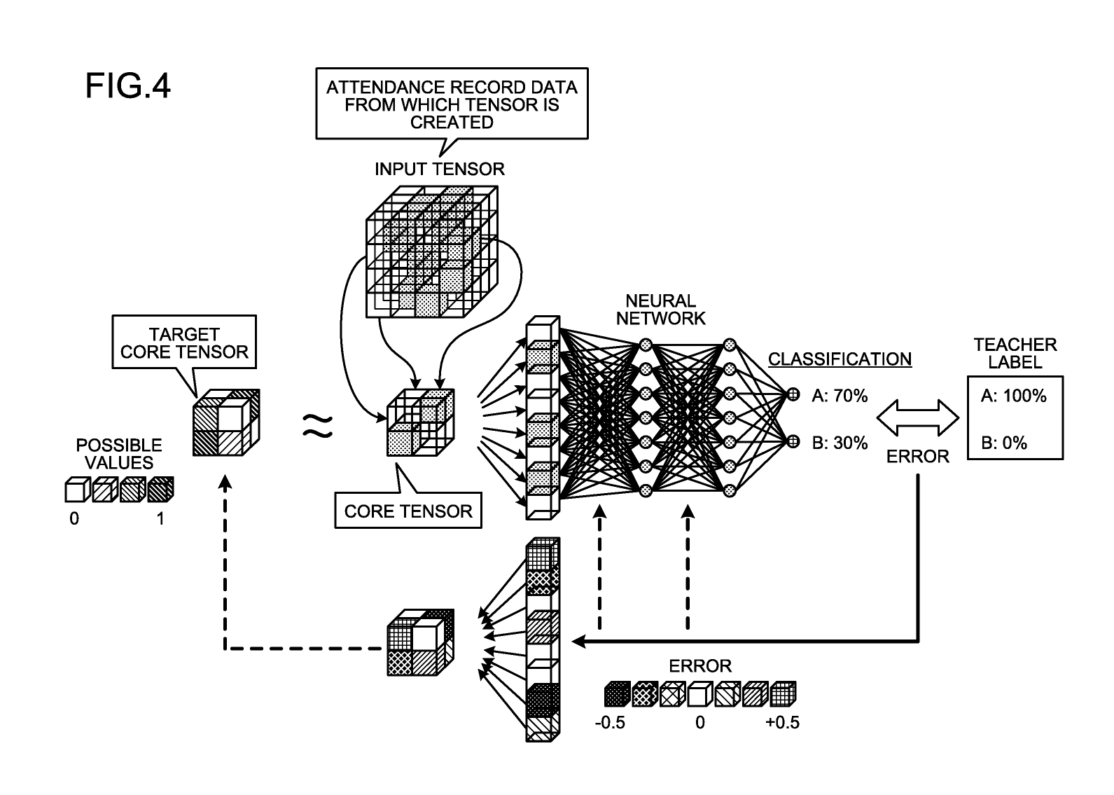

The following explains learning of Deep Tensor. FIG. 4 is a diagram for explaining a learning example of Deep Tensor. As illustrated in FIG. 4, the learning device 100 generates tensor data from attendance record data attached with a teacher label (label A) such as “with sick leave”. The learning device 100 performs tensor decomposition with the generated tensor data as an input tensor to generate a core tensor so as to analogize to a target core tensor generated for the first time at random. Then, the learning device 100 inputs the core tensor to the neural network (NN: Neural Network) to obtain classification results (label A: 70%, label B: 30%). After that, the learning device 100 calculates a classification error between the classification results (label A: 70%, label B: 30%) and the teacher label (label A: 100%, label B: 0%).

The learning device 100 executes learning of a prediction model using the expanded error propagation method obtained by expanding the error back-propagation method. That is, the learning device 100 corrects various kinds of parameters of NN so that the classification error becomes smaller as the classification error is propagated toward lower layers through an input layer, an intermediate layer, and an output layer included in the NN. Furthermore, the learning device 100 causes the classification error to be propagated to the target core tensor to correct the target core tensor so as to be closer to a partial graph structure that contributes to prediction, that is, a feature pattern representing a feature that a person who takes suspension of work or a feature pattern representing a feature that a person who has not taken sick leave has. This correction allows an optimized target core tensor to have a partial pattern that contributes to the prediction extracted thereto.

When a prediction is performed, an input tensor is converted to a core tensor (a partial pattern of the input tensor) by tensor decomposition and the core tensor is input to a neural network, and thereby prediction results are obtained. The tensor decomposition allows the core tensor to be converted so as to analogize to the target core tensor. That is, a core tensor having a partial pattern that contributes to prediction is extracted.

Functional Configuration

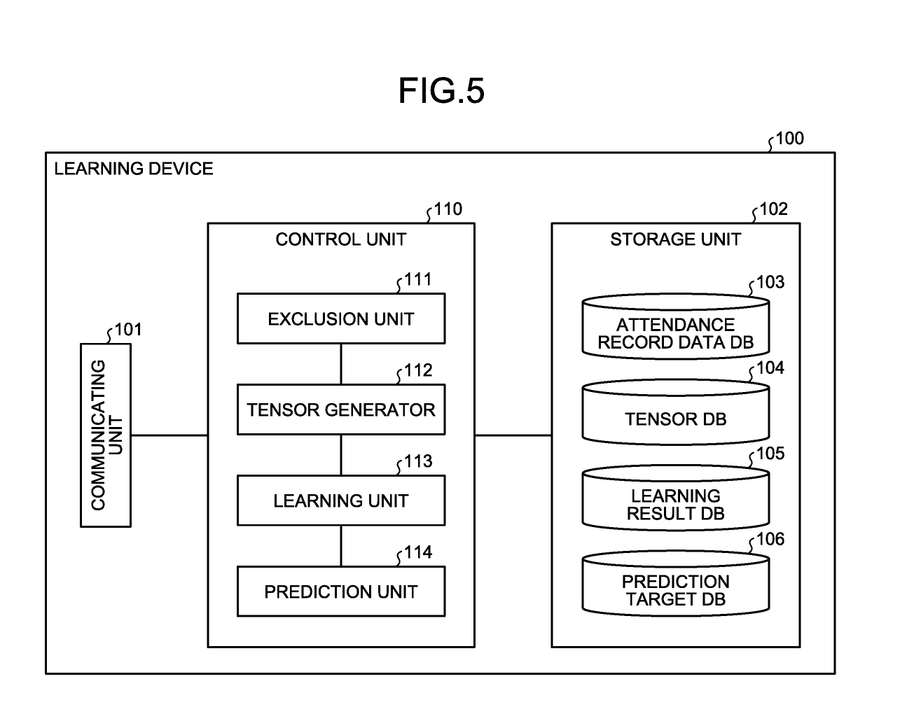

FIG. 5 is a functional block diagram illustrating a functional structure of the learning device 100 according to the first embodiment. As illustrated in FIG. 5, the learning device 100 includes a communicating unit 101, a storage unit 102, and a control unit 110.

The communicating unit 101 is a processing unit that controls communication with other devices, which provides a communication interface, for example. For example, the communicating unit 101 receives a process start instruction, attendance record data, and the like, from the terminal of an administrator. The communication unit 101 outputs learning results, prediction results of prediction target data, and the like, to the administrator terminal.

The storage unit 102 exemplifies a storage device that stores therein a computer program and data, such as a memory and a hard disk. This storage unit 102 stores therein an attendance record data DB 103, a tensor DB 104, a learning result DB 105, and a prediction target DB 106.

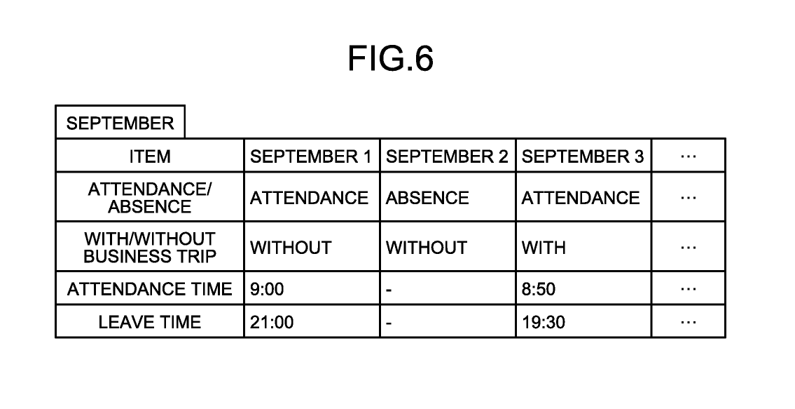

The attendance record data DB 103 is a database that stores therein attendance record data concerning the attendance of an employee or the like input by a user or the like. The attendance record data to be stored is attendance record data constituted of a plurality of records for a plurality of employees, the records each corresponding to a period of a calendar and having a plurality of items. Furthermore, the attendance record data is made by data organization based on attendance records used in respective companies, and is able to be obtained from various kinds of well-known attendance management systems or the like. FIG. 6 is a diagram illustrating an example of attendance record data stored in the attendance record data DB 103. As illustrated in FIG. 6, the attendance record data is constituted of records on a daily basis for each month (-month), and each record stores therein attendance information with values of items such as “attendance/absence, with/without business trip, attendance time, and leave time” being associated with one another. The example of FIG. 6 indicates that an employee “on September 1, attended at 9:00 and left at 21:00, instead of taking a business trip”.

It is noted that to the classification item of attendance/absence, a value corresponding to any one of items such as coming to the office, sick leave (suspension of work), accumulated holiday, paid holiday, and refresh vacation, is set. For the item of with/without business trip, a value of with/without a business trip is set, and the value corresponding to with or without taking a business trip are stored therein. It is noted that the above-described values are able to be distinguished with numbers or the like. For example, it is possible to distinguish the values in such a manner as attendance=0, sick leave=1, accumulated holiday=2, and paid holiday=3, for example. It is noted that a record unit of the attendance data record may be not only a daily unit but also a weekly or a monthly unit. Moreover, in accordance with a case where it is possible to take leave in an hourly unit, a value of hourly leave=4 may be set.

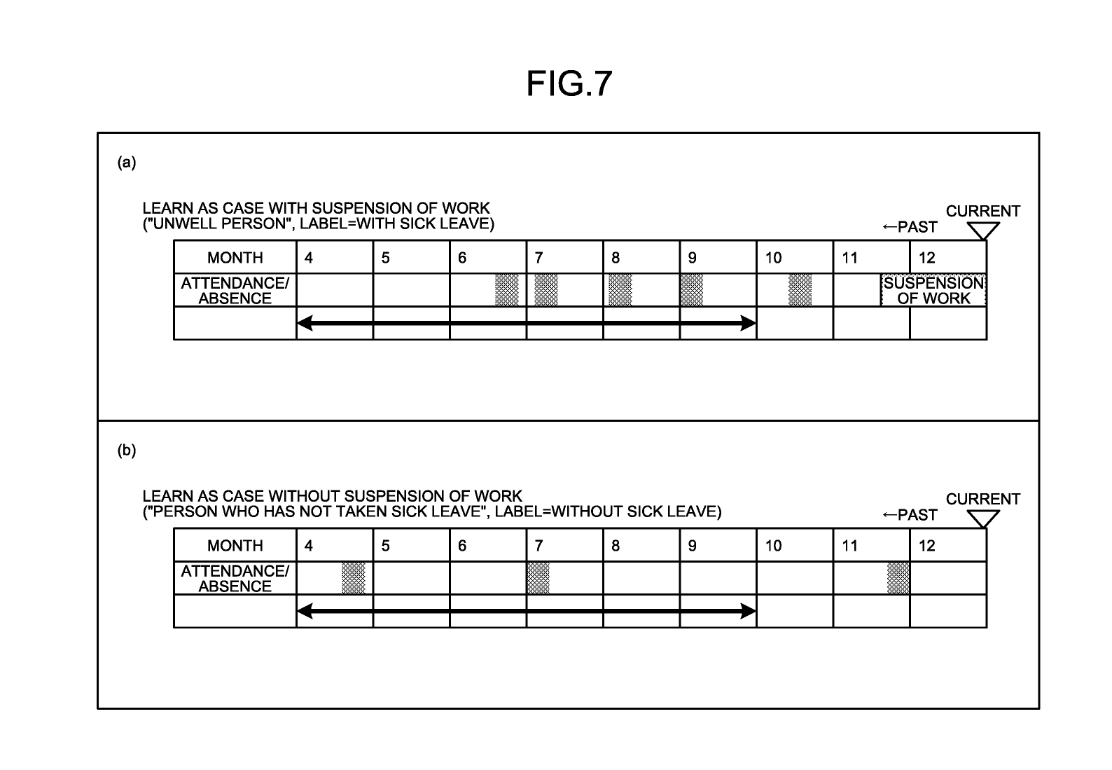

The attendance record data to be stored is learning data and has a teacher label attached thereto. FIG. 7 is a diagram for explaining an example of label setting. FIG. 7(a) exemplifies attendance record data of an unwell person who has taken sick leave, the attendance record data having a label of “with sick leave” attached thereto. FIG. 7(b) exemplifies attendance record data of a person who has not taken a suspension of work, the attendance record data having a label of “without sick leave” attached thereto. For example, with a tensor created from attendance record data for six months as a piece of training data, when a sick leave period exists that sick leave is taken within three months after the six months, it is possible to set a label of “with sick leave”, and when the sick leave does not exist within three months thereafter, it is possible to set a label of “without sick leave”.

A tensor DB 104 is a database that stores therein respective tensors (tensor data) generated from the attendance record data of the employees. This tensor DB 104 stores therein training data in which tensors and labels are associated with each other. For example, the tensor DB 104 stores therein “tensor data 1, label (with sick leave)”, “tensor data 2, label (without sick leave)”, and the like, as “tensor data, label”.

It is noted that settings of record items and tensor data labels in the above-described learning data are merely examples, and not limited to values and labels such as “with sick leave” and “without sick leave”. It is also possible to use various types of values and labels such as “a person who takes a suspension of work” and “a person who has not taken suspension of work”, and “with a suspension of work” and “without a suspension of work”, which are able to distinguish the existence of an unwell person.

The learning result DB 105 is a database that stores therein a learning result. For example, the learning result DB 105 stores a determination result (classification result) of learning data by the control unit 110, various parameters of NN and various parameters of Deep Tensor learned through machine learning or deep learning, and the like.

The prediction target DB 106 is a database that stores therein attendance record data of a target for which the existence of sick leave (suspension of work) is predicted using a learned prediction model. For example, the prediction target DB 106 stores therein attendance record data of a prediction target, tensor data generated from the attendance record data of the prediction target, and the like.

The control unit 110 is a processing unit that manages the whole processing of the learning device 100, and is a processor, for example. This control unit 110 includes an exclusion unit 111, a tensor generator 112, a learning unit 113, and a prediction unit 114. It is noted that the exclusion unit 111, the tensor generator 112, the learning unit 113, and the prediction unit 114 exemplify a process that is executed by an electronic circuit included in the processor or the like, or the processor or the like.

The exclusion unit 111 is a processing unit that generates exclusion data obtained by excluding, from the attendance record data, a record corresponding to the individual holidays that are set differently by the employees, and a record corresponding to the common holidays set commonly to the employees. That is, the exclusion unit 111 excludes, from the attendance record data that is data to be learned, a specified holiday (relevant holiday) on which attendance is not made, among the specified holidays including common holidays such as Saturdays, Sundays, and national holidays, individual holidays supplied by the company and that are set differently by the employees such as a summer vacation and a refresh vacation, and holidays specified by the company as holidays. Specifically, the exclusion unit 111 reads out the attendance record data stored in the attendance record data DB 103, excludes a specified holiday (relevant holiday) on which attendance is not made from the attendance record data, and outputs the attendance record data after the exclusion to the tensor generator 112.

For example, the exclusion unit 111 refers to attendance/absence in the attendance record data to locate specified holidays such as Saturdays, Sundays, and national holidays. Consequently, the exclusion unit 111 specifies a specified holiday on which attendance/absence does not fall on “attendance” with respect to the located specified holidays. Then, the exclusion unit 111 excludes (deletes) the located specified holiday as the relevant holiday from the attendance record data, and outputs the attendance record data after the exclusion to the tensor generator 112.

The tensor generator 112 is a processing unit that generates tensor data in which a tensor is created from each piece of attendance record data after a specified holiday (relevant holiday) on which attendance is not made is excluded, the piece of attendance record data being input from the exclusion unit 111. The tensor generator 112 creates a tensor with calendar information, and each of the items of “month, date, attendance/absence, with/without business trip, attendance time, and leave time” included in each piece of attendance record data as a dimension. The tensor generator 112 stores in the tensor DB 104 the created tensor (tensor data) being associated with a label (with or without sick leave) specified by a user or the like or a label (with or without sick leave) located based on the attendance/absence in the attendance record data. Learning is executed by Deep Tensor with the generated tensor data as input. It is noted that Deep Tensor, during learning, extracts a target core tensor that identifies a partial pattern of learning data having an influence on prediction, and executes the prediction based on the extracted target core tensor when the prediction is performed.

The tensor generator 112 generates a tensor from learning data with items that are assumed to characterize tendency of taking sick leave, such as frequent business trips, long overtime, repeated sudden absences, absence without notice, frequent holiday works, and a combination of any of these items, as dimensions. For example, the tensor generator 112 generates a fourth order tensor of four dimensions using four elements of month, date, attendance/absence, and with/without business trip. When four months of data are used, an element count for month is “4”, an element count of date is “31” based on the fact that the maximum number of days of a month is 31, an element count of attendance/absence is “3” based on the fact that types of attendance/absence are coming to the office, leave, and holiday, an element count of with/without business trip is “2” based on the fact that business trip is done or not done. Thus, a tensor generated from learning data is a tensor of “4×31×3×2” and a value of an element corresponding to an item among attendance/absence and with/without business trips in the months and dates in the learning data is 1, and a value of an element not corresponding to any of those items is 0. Any desired item is selectable as a dimension for a tensor or is determinable based on the past event.

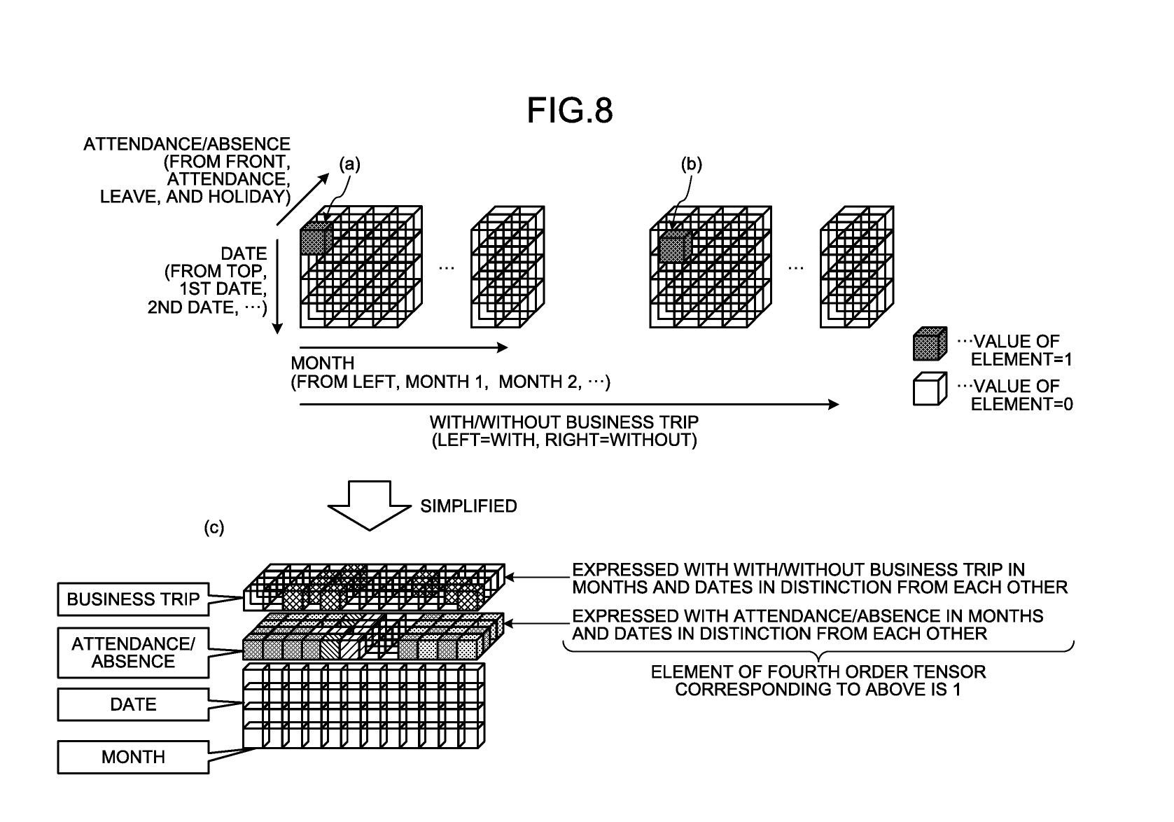

FIG. 8 is a diagram for explaining a specific example of creating a tensor. As illustrated in FIG. 8, a tensor generated by the tensor generator 112 represents data having horizontally months, vertically dates, attendance/absence in depth, a business trip from the left, and no business trip from the middle. Dates are represented in descending order with the first day as a top, and attendance/absence is represented with attendance, leave, and holiday in this order from the front side. For example, FIG. 8(a) represents an element of coming to the office and then taking a business trip on the first day of month 1, and FIG. 8(b) represents an element of taking a leave and not taking a business trip on the second day of month 1.

In the first embodiment, the above-described tensor is simplified to be described as in FIG. 8(c). That is, the tensor is expressed in a cube-shaped manner in which elements such as months, dates, attendance/absence, and with/without a business trip are stacked one another, with with/without a business trip in the months and dates expressed in distinction from each other, and with attendance/absence in the months and dates expressed in distinction from each other.

The learning unit 113 is a processing unit that performs deep learning of the neural network and learning of a method of tensor decomposition with respect to a learning model in which the tensor data is subjected to tensor decomposition as input tensor data, so as to be input to the neural network (NN). That is, the learning unit 113 executes learning of the learning model by Deep Tensor with the tensor data generated from each piece of the learning data and the label as input. Specifically, similarly to the method explained in FIG. 4, the learning unit 113 extracts a core tensor from tensor data to be input (input tensor) to input the extracted core tensor to NN, and calculates an error (classification error) between a classification result from NN and a label attached to the input tensor. Then, the learning unit 113 executes, using the classification error, learning of the parameters of NN and optimization of the target core tensor. The learning unit 113, after completing the learning, stores various kinds of parameters as learning results in the learning result DB 105.

The prediction unit 114 is a processing unit that predicts, using the learning results, a label of data that is to be determined. Specifically, the prediction unit 114 reads out the various kinds of parameters from the learning result DB 105, and builds Deep Tensor including the neural network in which the various kinds of parameters are set, and the like. The prediction unit 114 reads out attendance record data to be predicted from the prediction target DB 106, creates a tensor therefrom after excluding the relevant holiday in the same manner as in the exclusion unit 111, and inputs the created tensor to Deep Tensor. After that, the prediction unit 114 outputs a prediction result indicating with or without sick leave. The prediction unit 114, then displays the prediction result on a display or transmits the prediction result to the administrator terminal.

It is noted that the prediction unit 114 is able to perform prediction when the attendance record data to be predicted is input to the learning model as it is with the relevant holiday retained therein or when the attendance record data to be predicted is input to the learning model after the relevant holiday is deleted therefrom. Moreover, it is possible to input the attendance record data to be predicted by dividing by six months of data or input the attendance record data to be predicted as it is.

### SPECIFIC EXAMPLES

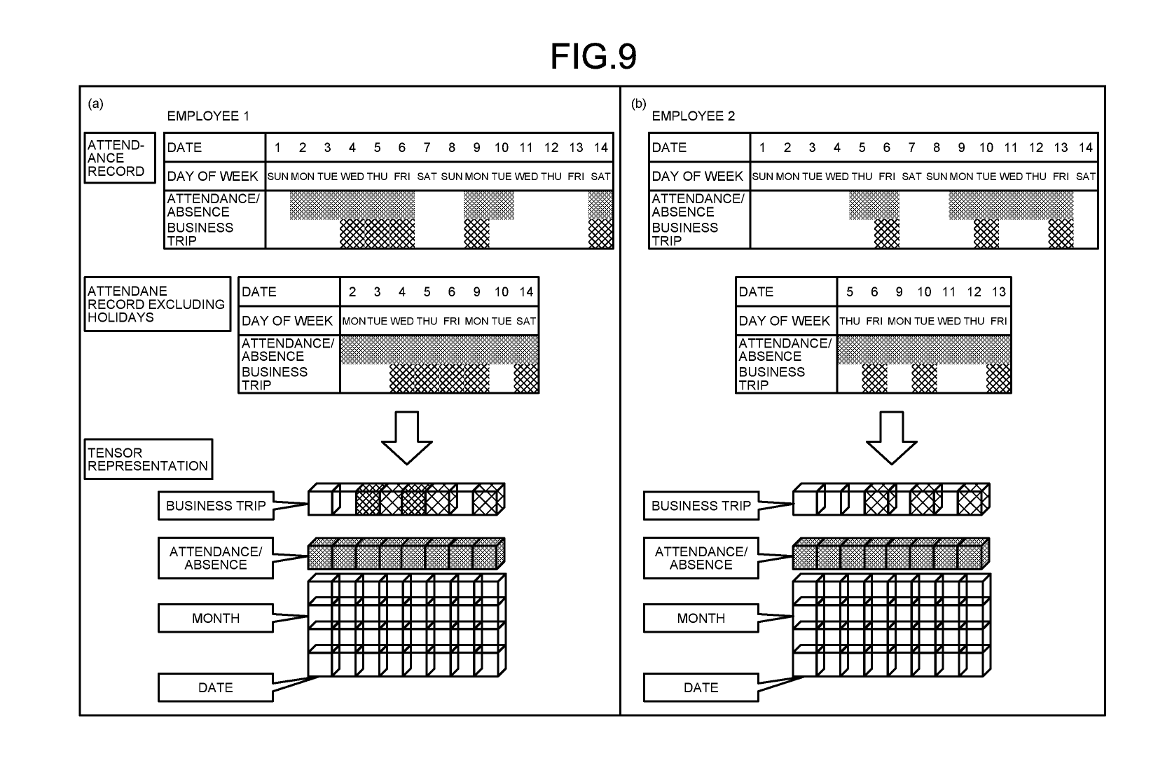

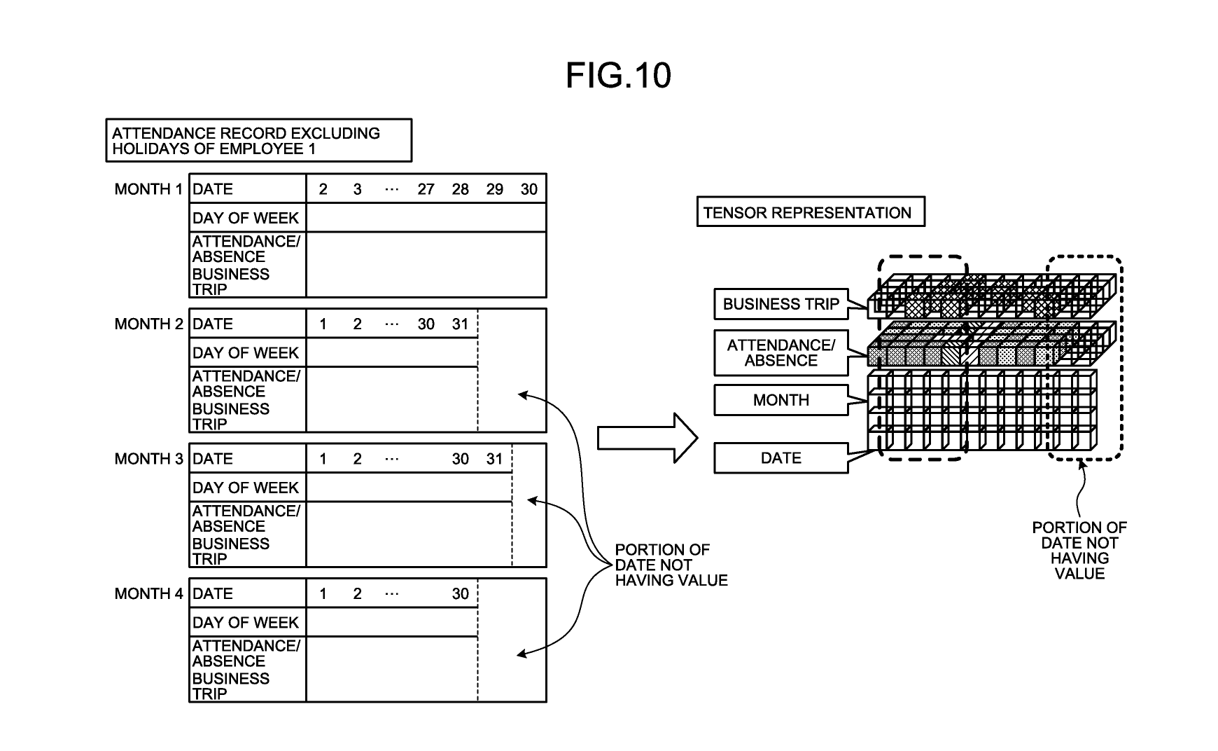

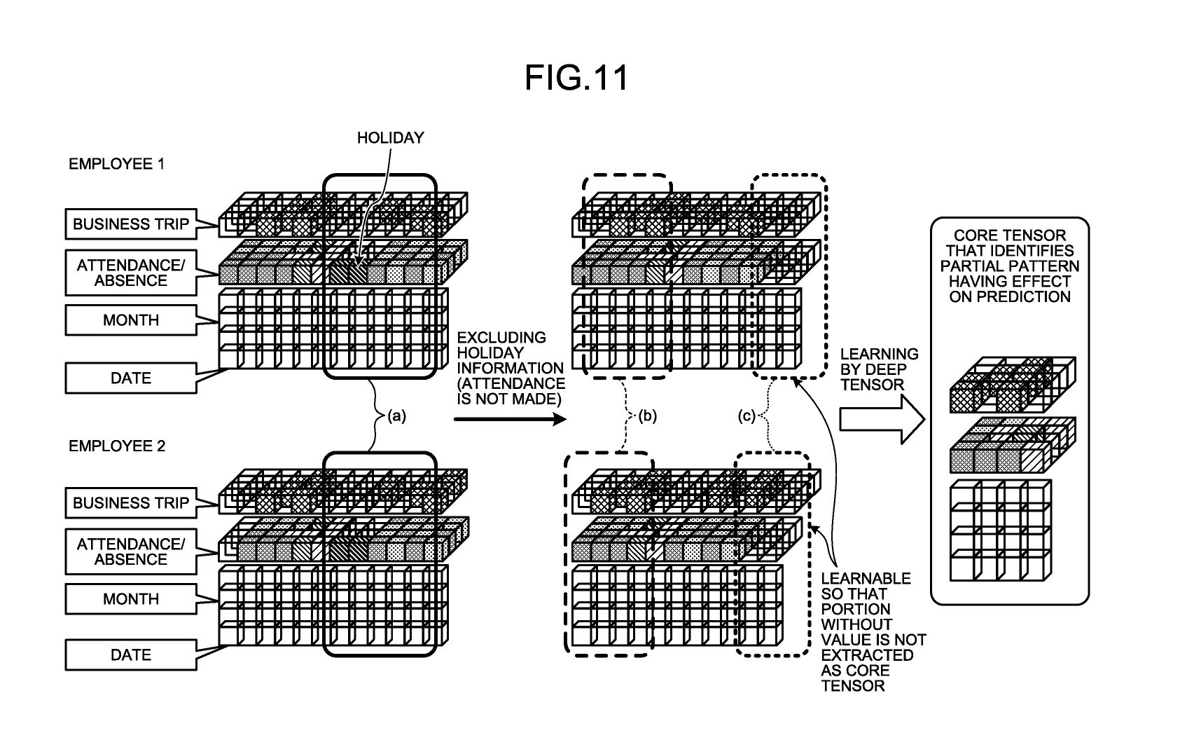

Next, the following describes, using FIGS. 9 to 11, a specific example of excluding the relevant holiday that indicates a specified holiday on which attendance is not made to creating a tensor. FIG. 9 is a diagram for explaining tensor representation in which the relevant holiday is excluded from the elements of a tensor. FIG. 10 is a diagram for explaining tensor representation for the excluded relevant holiday portion. FIG. 11 is a diagram for explaining an example of generating a core tensor according to the first embodiment.

In the example of FIG. 9(a), the exclusion unit 111 locates, from the attendance record data of an employee 1, dates 1 (SUN.), 7 (SAT.), 8 (SUN.), and holidays of 11 (WES.) to 13 (FRI.) and the like (for example, a refresh vacation or congratulation or condolence leave), and 14 (SAT.), which are specified holidays. Consequently, the exclusion unit 111 generates attendance record data from which dates 1, 7, 8, and 11 to 13 are deleted as the relevant holidays among the located specified holidays excluding 14 (SAT.) on which attendance is made. After that, the tensor generator 112 generates tensor data from the attendance record data from which dates 1, 7, 8, and 11 to 13 are deleted.

Furthermore, in the example of FIG. 9(b), the exclusion unit 111 specifies, from the attendance record data of an employee 1, days 1 (SUN.), holidays of 2 (MON.) to 4 (WED.) and the like (for example, a refresh vacation or congratulation or condolence leave), 7 (SAT.), 8 (SUN.), and 14 (SAT.), which are specified holidays. Consequently, the exclusion unit 111 generates attendance record data from which all of the located specified holidays are deleted as the relevant holidays, because the located specified holidays do not include a day on which attendance is made. Then, the tensor generator 112 generates, from the attendance record data from which the specified holidays are deleted, tensor data.

In accordance with differences in the number of days per month, a period of holidays individually selected, and with/without attendance on a holiday, there may be a different number of days per month. In this case, tensor data has a difference in size. Then, a portion corresponding to a date not having a value in a tensor is assumed to be an empty element, so that different months have the same date size in tensor representation.

Specifically, as illustrated in FIG. 10, when a tensor is created from the attendance record data including data of month 2, month 3, and month 4, each of which has the relevant holiday excluded therefrom, the tensor generator 112 sets an empty element for a portion of a date not having a value, the date corresponding to the relevant holiday deleted, in each of month 2, month 3, and month 4, so that each of the months has the same size of dates as that of month 1. The tensor generator 112 is made to learn so as to assume the weight of an element of a portion of a date not having a value in the tensor to be zero, and not to extract the portion of the date not having a value as a core tensor. Assuming the weight to be zero refers to that a value of an element matrix for generating a core tensor, for example, is set to zero.

Deep Tensor enables exclusion from a target from which a core tensor is extracted by setting the weight to be zero as described above. As illustrated in FIG. 11, excluding the relevant holiday can prevent the case that the portion of the relevant holiday is recognized as a core tensor (FIG. 11(a)) and helps an important portion (FIG. 11(b)) more recognized. That is, the learning unit 113 uses properties of Deep Tensor, when creating a tensor from the attendance record data of each of employee 1 and employee 2, to be able to exclude portions the weight of which is zero, the values of which being paired (FIG. 11(c)), from a target of a core tensor, thereby precisely extracting a core tensor that identifies a partial pattern that has effect on prediction. As a result, it is possible to execute learning that can improve the accuracy of prediction.

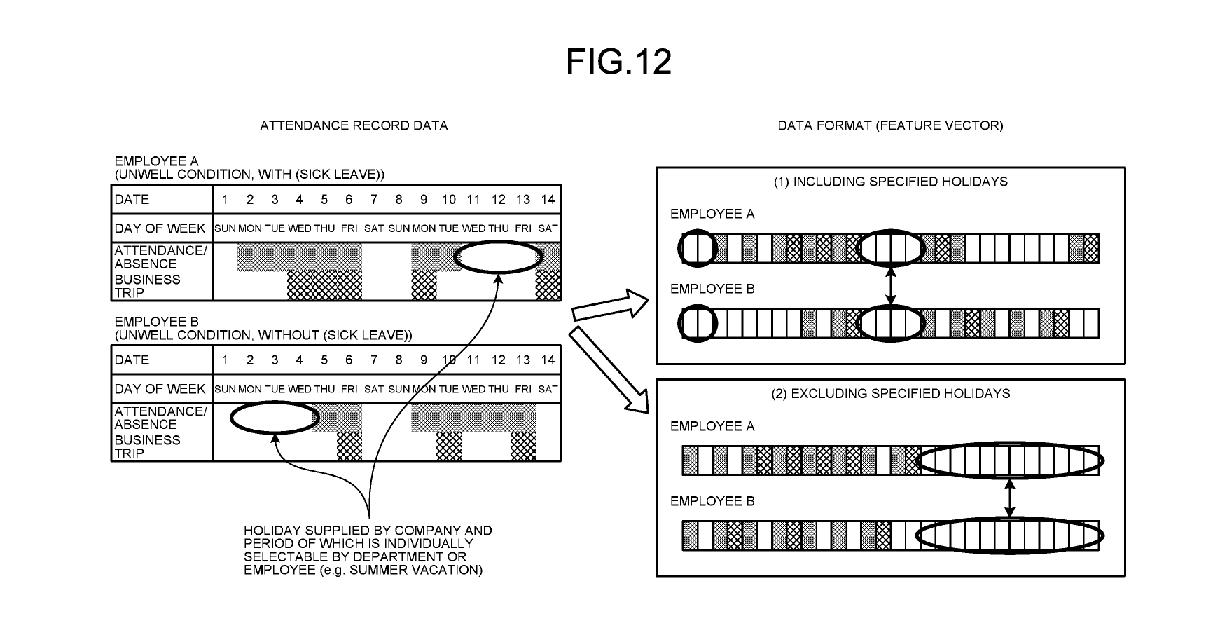

It is noted that, in general machine learning, the input of a feature vector having a fixed length is a prerequisite, and it is not possible to correctly perform learning processing simply by deleting the portion of the relevant holiday. Thus, it is probable to complement an element for a deleted number of days, but the improvement of the accuracy of learning is not expectable even with the complementation. FIG. 12 is a diagram for explaining the problem that is caused by general machine learning. FIG. 12 gives an explanation with attendance record data of employee A with sick leave and attendance record data of employee B without sick leave as examples.

As illustrated in FIG. 12, it is assumed that among the attendance record data of employee A as a learning target, dates 11 to 13 are the relevant holidays to be deleted, and among the attendance record data of employee B to be predicted, dates 2 to 4 are the relevant holidays to be deleted.

In the example of FIG. 12(1), without deleting an element of the relevant holiday, complementation is performed by setting zero with the element of the relevant holiday as a NULL value. In general machine learning, when data of the employee A is learned data and data of the employee B is data to be predicted, it is determined that similarity is higher as attribute values in the same position in respective feature vectors are matched. Thus, in this example, as the number of elements surrounded with the box increases, the similarity between the employee B and the employee A is determined to be higher, and it is more probable to determine the employee B is in unwell condition.

In the example of FIG. 12(2), after the element of the relevant holiday is deleted, in order to match the fixed length of input data, the elements are left aligned to complement empty elements behind. In this case, when data of the employee A is learned data and data of the employee B is data to be predicted, portions in which the relevant holidays are complemented are recognized as elements having the same attribute value. Therefore, compared with the case of (1), the similarity between the employee B and the employee A becomes higher and it is more probable to determine that the employee B is in unwell condition.

In this manner, in general machine learning, when the relevant holiday is deleted, an empty element is completed for the reason of restriction that the input data has a fixed length. However, the complemented empty elements are similar among learning data, resulting in degradation of the accuracy of learning.

Processing Flow

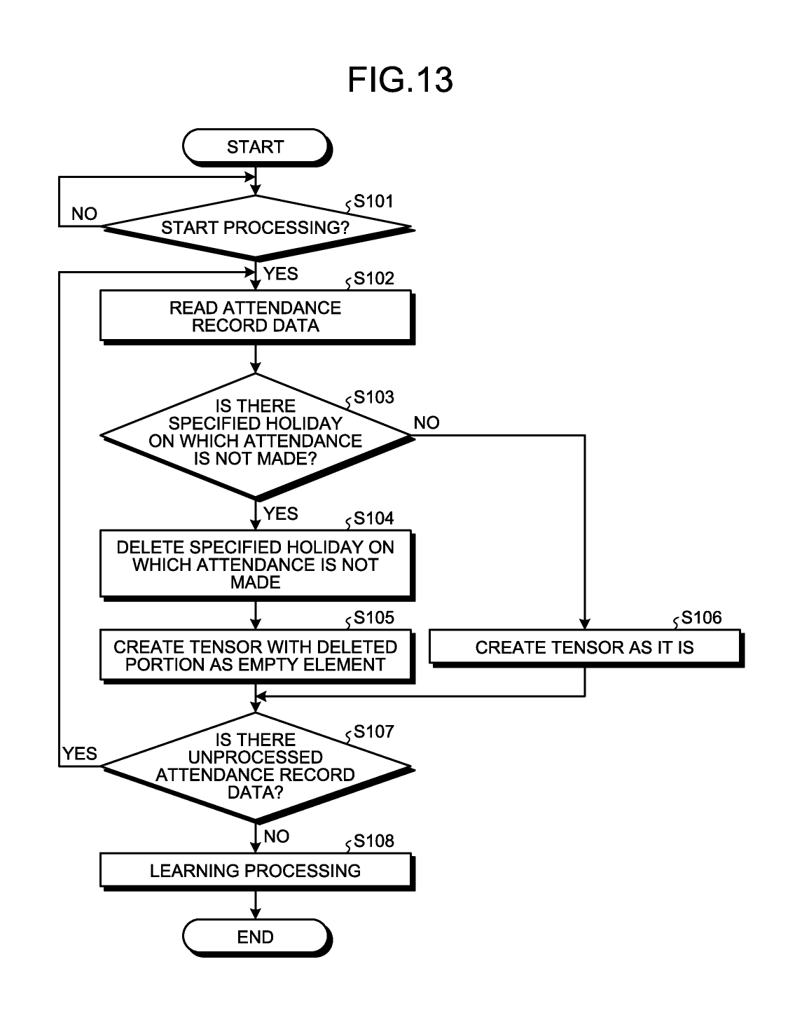

FIG. 13 is a flowchart illustrating the flow of learning process. As illustrated in FIG. 13, upon receiving an instruction to start processing (S101: Yes), the exclusion unit 111 reads attendance record data from the attendance record data DB 103 (S102), and determines whether there exists a specified holiday (relevant holiday) on which attendance is not made (S103).

Then, when there exists a specified holiday on which attendance is not made (S103: Yes), the exclusion unit 111 deletes a specified holiday on which attendance is not made from the attendance record data (S104), and the tensor generator 112 inserts an empty element to the deleted portion to create a tensor from the attendance record data (S105).

By contrast, when there is not any specified holiday on which attendance is not made (S103: No), the tensor generator 112 create a tensor from the attendance record data as it is (S106).

After that, when there exists unprocessed attendance record data (S107: Yes), for the next attendance record data, S102 and the subsequent steps are repeated. By contrast, when there is not any unprocessed attendance record (S107: No), the learning unit 113 executes, using the tensors and labels stored in the tensor DB 104, learning process (S108).

Effect

As described above, the learning device 100 is capable of executing learning processing with a feature pattern of a specified holiday on which attendance is made being excluded from the learning data, so that it is possible to execute learning process by extracting a feature pattern of a day other than the specified holiday, instead of a feature pattern including the specified holiday that is an item common to the learning data. As a result, the learning device 100 is capable of preventing learning of a wrong feature pattern from proceeding and thereby preventing degradation of the accuracy of learning.

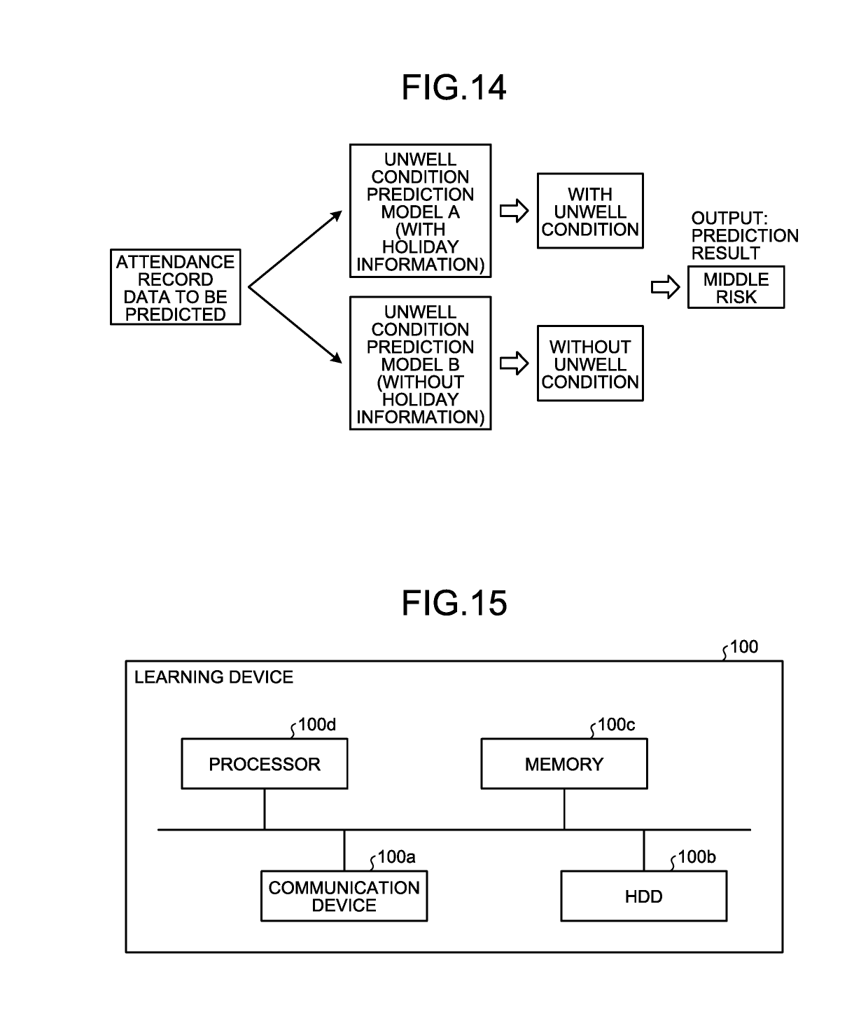

The learning device 100 is capable of setting a priority of prediction results by using a learning model (prediction model) from which holiday information such as specified holiday is excluded together with a learning model including the holiday information. FIG. 14 is a diagram for explaining another example of the prediction method. As illustrated in FIG. 14, the learning device 100 generates not only a learning model A by learning processing using the learning data including the holiday information but also a learning model B by learning processing using the learning data from which the holiday information is excluded.

Then, the learning device 100 inputs the attendance record data as a prediction target to the learning model A and the learning model B, and, according to the prediction results from the respective learning models, determines the risk of sick leave of the employees. Specifically, the learning device 100 determines a result of “both learning models predict unwell condition” to be the high risk, and a result of “either learning model predicts unwell condition” to be the middle risk, and a result of “none of the learning models predicts unwell condition” to be the low risk.

In the example of FIG. 14, the occurrence of the unwell condition is predicted by the learning model A and no occurrence of the unwell condition is predicted by the learning model B, and thus an employee corresponding to the input attendance record data is determined to have middle risk. It is possible to input the attendance record data with the holiday information retained therein to each of the learning models. It is also possible to input the attendance record data with the holiday information retained therein to the learning model A and input the attendance record data from which the holiday information deleted to the learning model B.

### [b] Second Embodiment

Although the embodiments of the present invention have been explained, the present invention may be implemented in various kinds of different aspects in addition to the above-described embodiments.

Learning

The above-described learning process may be executed for any desired number of times. For example, the learning process may be executed using all pieces of training data, or may be executed for a certain number of times. Furthermore, as a method for calculating a classification error, a known calculation method such as the least square method may be employed, or a general calculation method used in NN may be employed. It is noted that learning weight or the like of a neural network by inputting tensor data to the neural network, so as to be able to classify an event (for example, with sick leave and without sick leave), using learning data, corresponds to an example of a learning model.

While the explanation is made with attendance record data for six months as example data used for prediction, it is not limited thereto, but may be optionally changed to attendance record data for four months or the like. Moreover, while the explanation is made to the example in which a label is attached to attendance record data for six months depending on whether sickness leave (suspension of work) is taken within three months after the end time thereof, it is not limited thereto, but may be optionally changed to within two months or the like. The order of tensor data is not limited to fourth order, and tensor data below the fourth order may be generated, or tensor data of a fifth order or more may be generated. Not only attendance record data but also any other format of data may be used as far as it provides conditions of employees or the like, such as coming to the office, leaving the office, and taking leave.

In the above-described example, although an example is explained that the exclusion unit 111 excludes the relevant holiday that is a holiday on which attendance is not made among the specified holidays from the attendance record data, it is not limited thereto, but it is possible to exclude all of the specified holidays.

Neural Network

In the second embodiment, various kinds of neural networks such as RNN (Recurrent Neural Networks) and CNN (Convolutional Neural Network) may be used. For a method of learning, various kinds of known methods may be employed in addition to the error back-propagation method. A neural network has a multistage configuration including an input layer, an intermediate layer (hidden layer), and an output layer, for example, the layers each having a structure in which a plurality of nodes are tied with edges. Each of the layers has a function called “activation function”, each edge having “weight”, the value of each node being calculated based on the value of a node in the previous layer, the value of weight of a connection edge (weighting factor), and the activation function that the layer has. For a calculation method, various kinds of known methods are able to be employed.

Learning in a neural network refers to correcting parameters, that is, weight and bias so that the output layer has a correct value. In the error back-propagation method, “loss function” is determined that indicates how far the value of the output layer is away from a proper condition (desired condition) with respect to the neural network, and the weight and the bias are updated so that the loss function can be minimized using the steepest descent method and the like.

System

Process procedures, control procedures, specific names, and information including various kinds of data and parameters represented in the above description and drawings may be optionally changed unless otherwise specified. The specific example, distribution, numeric values explained in the embodiments are merely examples, and may be optionally changed.

In addition, each component of each device illustrated in the drawings is a functional idea and thus is not always be configured physically as illustrated in the drawings. That is, specific forms of the distribution and integration of each device are not limited to those in the drawings. In other words, all or part of the devices may be functionally or physically distributed or integrated in any desired unit according to various kinds of loads and operating conditions. Moreover, all or any desired part of the processing functions of the devices are implemented by CPU and a computer program analyzed or executed by the CPU, or may be implemented as hardware with wired logic.

Hardware

FIG. 15 is a diagram for explaining a hardware configuration example. As illustrated in FIG. 15, the learning device 100 includes a communication device 100a, a hard disc drive (HDD) 100b, a memory 100c, and a processor 100d. The units illustrated in FIG. 15 are connected through buses one another.

The communication device 100a is a network interface card or the like, which communicates with other servers. The HDD 100b stores therein a computer program and a database that operate the functions illustrated in FIG. 5.

The processor 100d reads out from HDD 100b or the like to develop in the memory 100c a computer program that executes the same processing as that executed by the processing units illustrated in FIG. 5, so as to operate the process that executes the functions explained in FIG. 5 and the like. That is, the process executes the same functions as those of the processing units included in the learning device 100. Specifically, the processor 100d reads out from the HDD 100b or the like the computer program that has the same functions as those of the exclusion unit 111, the tensor generator 112, the learning unit 113, the prediction unit 114, and the like. Then the processor 100d executes the process that executes the same processing as that executed by the exclusion unit 111, the tensor generator 112, the learning unit 113, the prediction unit 114, and the like.

In this manner, the learning device 100 operates as an information processing device that executes a learning method by reading out to execute the computer program. Moreover, the learning device 100 is capable of implementing the same functions as those described in the above-described embodiments by allowing a media reader to read out the computer program from a recording medium to execute the read computer program. It is noted that the computer program referred to in other embodiments than the above-described embodiments is not limited to being executed by the learning device 100. For example, it is possible to apply the present invention similarly when another computer or server executes the computer program or these computer and server execute the computer program in cooperation with one another.

This computer program is distributable via a network such as the Internet. Furthermore, this computer program may be stored in a computer-readable recording medium such as a hard disc, a flexible disc (FD), a compact disc read-only memory (CD-ROM), a magneto optical disk (MO), or a digital versatile disc (DVD), and may be executed by being read out from the recording medium.

According to the embodiments, it is possible to prevent the accuracy of learning from being degraded.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
receiving attendance record data for a plurality of employees, the attendance record data corresponding to a period of a calendar, the attendance record data including a plurality of records including a plurality of items,
first generating exclusion data by excluding a record corresponding to an individual holiday that is differently set by the employees, and a record corresponding to a common holiday set commonly to the employees, from the attendance record data;
second generating, based on the generated exclusion data, tensor data in which a tensor is created with calendar information and the items including different dimensions; and
performing deep learning of a neural network and learning of a method of tensor decomposition with respect to a learning model in which the tensor data is subjected to the tensor decomposition as input tensor data to be inputted to the neural network.

2. The non-transitory computer-readable recording medium having stored therein the program according to claim 1, wherein the first generating includes generating the exclusion data from which a holiday on which a relevant employee does not attend, is excluded, among the individual holiday and the common holiday included in the attendance record data.

3. The non-transitory computer-readable recording medium having stored therein the program according to claim 1, wherein the performing includes, when generating the tensor data, generating tensor data in which an empty element is added to a portion of the excluded holiday, with the tensor data generated from the attendance record data of the employees having a same size, performing deep learning of the neural network, and learning a method of the tensor decomposition.

4. The non-transitory computer-readable recording medium having stored therein the program according to claim 3, wherein the process further comprising:
during the tensor decomposition, assuming the weight of a tensor portion corresponding to the empty element to be zero, excluding the tensor portion from a target for generating a core tensor from the tensor data.

5. A machine learning method comprising:
receiving attendance record data for a plurality of employees, the attendance record data corresponding to a period of a calendar, the attendance record data including a plurality of records including a plurality of items, using a processor,
generating exclusion data by excluding a record corresponding to an individual holiday that is differently set by the employees, and a record corresponding to a common holiday set commonly to the employees, from the attendance record data, using the processor,
generating, based on the generated exclusion data, tensor data in which a tensor is created with calendar information and the items including different dimensions, using the processor; and
performing deep learning of a neural network and learning of a method of tensor decomposition with respect to a learning model in which the tensor data is subjected to the tensor decomposition as input tensor data to be inputted to the neural network, using the processor.

6. A machine learning device comprising:
a memory; and
a processor coupled to the memory and the processor configured to:
receive attendance record data for a plurality of employees, the attendance record data corresponding to a period of a calendar, the attendance record data including a plurality of records including a plurality of items,
generate exclusion data by excluding a record corresponding to an individual holiday that is differently set by the employees, and a record corresponding to a common holiday set commonly to the employees, from the attendance record data;
generate, based on the generated exclusion data, tensor data in which a tensor is created with calendar information and the items including different dimensions; and
perform deep learning of a neural network and learning of a method of tensor decomposition with respect to a learning model in which the tensor data is subjected to the tensor decomposition as input tensor data to be inputted to the neural network.
